(19) United States
(12) Patent Application Publication
(10) Pub. No.: US 2026/0160348 A1
(43) Pub. Date: Jun. 11, 2026

(54) CHECK VALVE

(71) Applicants: Hyundai Motor Company, Seoul (KR); Kia Corporation, Seoul (KR)

(72) Inventor: Myeong Seok KIM, Hwaseong-Si (KR)

(21) Appl. No.: 19/222,428

(22) Filed: May 29, 2025

(30) Foreign Application Priority Data
Dec. 11, 2024 (KR) 10-2024-0184235

(51) Int. Cl. F16K 15/06; F16K 27/02

(52) U.S. Cl. CPC F16K 15/063; F16K 27/0209

(57) ABSTRACT

A check valve may reduce a filling differential pressure by reducing an opening pressure of a valve plunger in an environment in which a hydrogen fuel is filled. The check valve may prevent leakage of the hydrogen fuel in a high-pressure environment in which a high-pressure state is applied to a fuel passage due to reverse flow of the hydrogen fuel.

### CROSS-REFERENCE TO RELATED APPLICATION

This application claims the benefit of priority to Korean Patent Application No. 10-2024-0184235, filed in the Korean Intellectual Property Office on Dec. 11, 2024, the entire contents of which are incorporated herein by reference.

### TECHNICAL FIELD

The present disclosure relates to a check valve, and more particularly, to a check valve that may reduce a filling differential pressure by reducing an opening pressure of a valve plunger in an environment in which a hydrogen fuel is filled and/or may prevent leakage of the hydrogen fuel in a high-pressure environment in which a high-pressure state is applied to a fuel passage due to reverse flow of the hydrogen fuel.

### BACKGROUND

In general, a fuel cell electric vehicle (FCEV) generates electric energy by/via an electrochemical reaction between oxygen and hydrogen in a fuel cell stack and uses the generated electric energy as a power source.

The FCEV may generate power regardless of a capacity of a cell by supplying fuel (e.g., hydrogen) and air (e.g., from the outside and/or other oxygen source) and/or may have high efficiency and little pollutant emission.

The FCEV may be provided with a plurality of hydrogen tanks. Hydrogen may be stored in the hydrogen tanks (e.g., along a hydrogen filling line of a hydrogen storage system). The hydrogen stored in the hydrogen tank may be decompressed by/via a regulator along a hydrogen supply line and supplied to the fuel cell stack to generate electrical energy.

Further, the FCEV may be provided with a hydrogen filling receptacle as a kind of connector connected to a filling nozzle (e.g., that supplies a hydrogen gas). The hydrogen supplied via/from/by the receptacle may be stored in the hydrogen tank in/by a manifold. The receptacle may be provided with a check valve for preventing reverse flow of the hydrogen.

After the hydrogen tank is filled with the hydrogen (e.g., immediately after), an internal pressure of the hydrogen filling line connecting the receptacle to the manifold and/or of the manifold may be maintained at a high pressure (e.g., about 700 bar or more).

If/when the internal pressure of the hydrogen filling line is maintained at a high pressure, and/or if the hydrogen fuel is introduced into the check valve in a filled state, an opening pressure of the check valve may increase. In this case, a filling differential pressure may be generated at both ends of the check valve, and operation noise (e.g., abnormal/undesired operation noise) may occur (e.g., due to a chattering phenomenon of the check valve according to the filling differential pressure).

Further, when/if an inside of the hydrogen filling line is maintained at a high pressure, a risk of hydrogen leakage in the hydrogen filling line may increase, and thus safety and/or reliability may decrease. For example, since the check valve may have a structure that prevents leakage via a reaction force of a spring (e.g., just via the reaction force of the spring), fine leakage may occur when/if the reaction force of the spring is reversed in this high-pressure environment.

Accordingly, it is desired to minimize/reduce occurrence of a differential pressure in the check valve that controls the filling of the hydrogen and to improve stability and/or reliability.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for check valve. A check valve may comprise: a valve housing comprising a valve seat at an inlet of the valve housing; a valve body forming a fuel passage between an inlet of the valve body and an outlet of the valve body; a valve plunger, movable inside the valve body, configured to selectively open or close the valve seat, and forming an elastic body mounting space; an elastic body, in the elastic body mounting space, elastically connected to the valve plunger; a force distributing base comprising a first piston and a second piston with a fluid therebetween, wherein the first piston and the second piston are configured to transmit, via the fluid and to each other, a flow pressure of a hydrogen fuel; and a drain passage configured to allow the elastic body mounting space to communicate pressure with an outside of the valve housing.

A check valve may also, or alternatively, comprise: a valve housing; valve seat; a valve body forming a fuel passage between a first end of the valve body and a second end of the valve body; a valve plunger, movable inside the valve body, configured to selectively open or close the valve seat, and forming an elastic body mounting space; an elastic body, in the elastic body mounting space, elastically connected to the valve plunger; a first piston disposed in a first cylinder, wherein the elastic body is elastically connected to the first piston; a second piston disposed in a second cylinder; and a fluid, filling a space formed between the first piston and the second piston, and configured to transmit a force applied to either the first piston or the second piston to the other of the first piston or the second piston.

A check valve may also, or alternatively, comprise: a valve housing; a valve seat; a valve body forming a fuel passage between a first end of the valve body and a second end of the valve body; a valve plunger, movable inside the valve body, configured to selectively open or close the valve seat, and forming an elastic body mounting space; an elastic body, in the elastic body mounting space, elastically connected to the valve plunger; a drain passage configured to selectively allow pressure balancing between the elastic body mounting space and an outside of the valve housing; and an electronic control circuit configured to control, based on an inflow amount of hydrogen fuel flowing into the valve body, an opening of the drain passage to allow the pressure balancing between the elastic body mounting space and the outside of the valve housing.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a hydrogen filling system according to an example of the present disclosure;

FIG. 2 is a cut-away perspective view illustrating a check valve according to a first example of the present disclosure;

FIG. 3 is an exploded perspective view illustrating the check valve according to the first example of the present disclosure;

FIG. 4 is a cross-sectional view illustrating the check valve according to the first example of the present disclosure;

FIG. 5 is a cross-sectional view illustrating a check valve according to a second example of the present disclosure;

FIG. 6 is a cross-sectional view illustrating a force distributing mechanism of the check valve according to the example of the present disclosure;

FIG. 7 is a view illustrating an operation state of the check valve in an environment in which a hydrogen fuel is filled according to the first example of the present disclosure; and

FIG. 8 is a view illustrating an operation state of the check valve in an environment in which the hydrogen fuel is provided at a high pressure according to the first example of the present disclosure.

### DETAILED DESCRIPTION

Hereinafter, some examples of the present disclosure will be described in detail with reference to the exemplary drawings. It should be noted that, when the reference numerals are added to the components of the drawings, the same components have the same reference numerals as much as possible even when the components are illustrated in different drawings. Further, in describing the example of the present disclosure, a detailed description of the related known configuration or function will be omitted when it is determined that it interferes with the understanding of the example of the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method.

Further, in the description of components of the examples of the present disclosure, the terms such as first, second, A, B, (a) and (b) may be used. These terms are merely intended to distinguish one component from other components, and the terms do not limit the nature, order, or sequence of the components. It should be understood that when one component is “connected”, “coupled” or “joined” to another component, the former may be directly connected, coupled, or joined to the latter or may be “connected”, “coupled” or “joined” to the latter with a third component interposed therebetween, unless “directly” is explicitly stated.

Unless otherwise defined, the terms used herein, including technical or scientific terms, may have meanings generally understood by those skilled in the art to which the present disclosure belongs. A singular expression used herein may include the meaning of the plural unless otherwise stated in the context, which also applies to the singular expression described in the claims. The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

The expression “based on” as used herein is intended to describe one or more factors that influence an act or operation of determining or deciding described in a phrase or sentence including that expression, and this expression does not exclude any additional factors that influence the act or operation of determining or deciding.

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

Hereinafter, before describing a check valve according to various examples of the present disclosure in detail with reference to the accompanying drawings, a hydrogen filling system in which the check valve is installed will be schematically described.

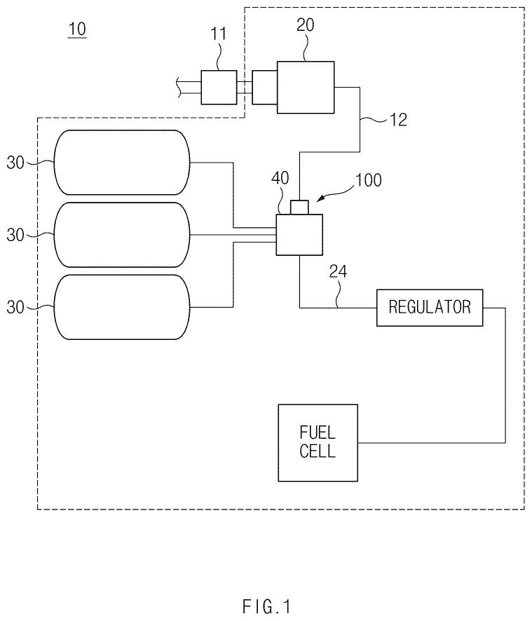

FIG. 1 is a view illustrating a hydrogen filling system according to an example of the present disclosure.

Referring to FIG. 1, a hydrogen filling system 10 according to an example of the present disclosure includes a receptacle 20 (e.g., which is provided in a FCEV) and to which a filling nozzle 11 that supplies hydrogen (e.g., to the hydrogen filling system) is connected, a manifold 40 connected to a hydrogen tank 30 (e.g., one or more hydrogen tanks provided in the FCEV), a hydrogen filling line 12 connecting the receptacle 20 and the manifold 40, and a check valve 100 that is provided between the receptacle 20 and the manifold 40. The check valve 100 may control supply of the hydrogen to the manifold 40 (e.g., via/along the hydrogen filling line 12).

For reference, the hydrogen filling system 10 according to the example of the present disclosure may be applied to passenger vehicles and/or commercial vehicles. The present disclosure is not restricted or limited by the type and structure of the vehicles to which the hydrogen filling system 10 is applied.

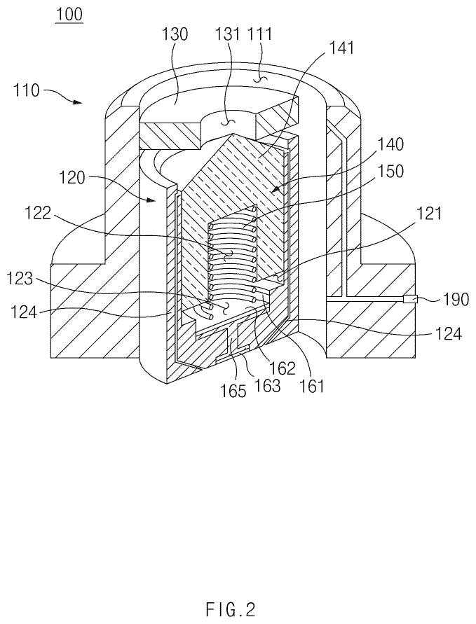

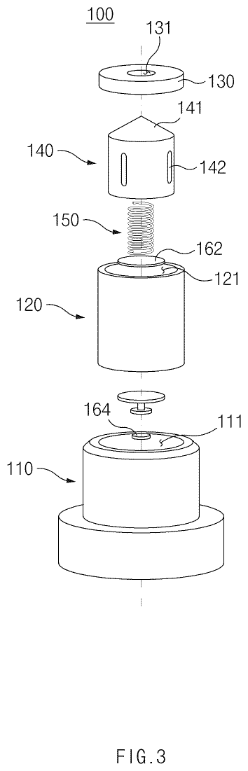

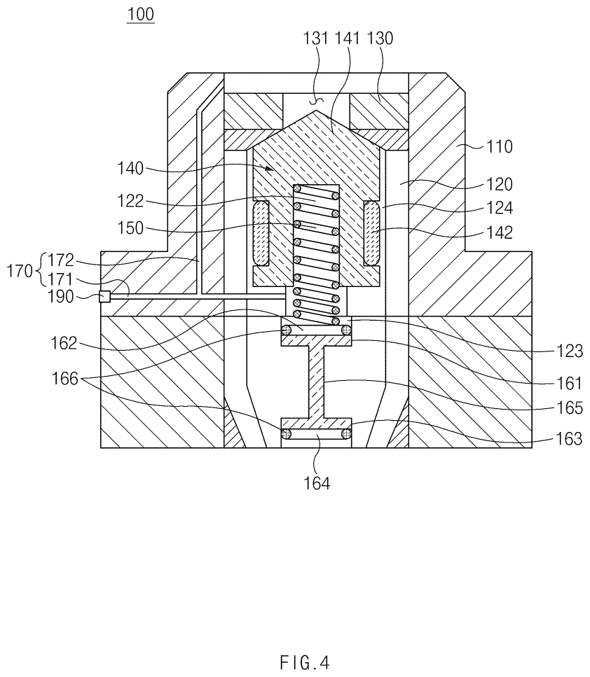

FIG. 2 is a cut-away perspective view illustrating the check valve 100 according to a first example of the present disclosure, FIG. 3 is an exploded perspective view illustrating the check valve 100 according to the first example of the present disclosure, and FIG. 4 is a cross-sectional view illustrating the check valve 100 according to the first example of the present disclosure.

Referring to the accompanying drawings, the check valve 100 may be connected to the hydrogen filling line 12 between the receptacle 20 and the manifold 40 of FIG. 1.

The check valve 100 may be formed to have various structures capable of preventing reverse flow of a hydrogen fuel while controlling the amount of the hydrogen fuel supplied to the hydrogen tank 30.

The check valve 100 may include a valve seat 130 installed at an inlet side of the check valve 100. The check valve 100 may include a valve housing 110 including a cylindrical portion 111 having a cylindrical shape (e.g., approximately/substantially cylindrical shape). The check valve 100 may include a valve body 120 which includes/forms a fuel passage 124 connected to/between an inlet (e.g., of the valve body 120 and/or of the valve housing 110), an outlet (e.g., of the valve body 120 and/or of the valve housing 110), and the hydrogen filling line 12. A plunger mounting space 121 may be formed in the fuel passage 124. The plunger mounting space 121 may be configured to guide a valve plunger 140.

### Valve Housing

The valve housing 110 may be mounted (e.g., firmly, securely, fixedly, etc.) on a mounting space of the receptacle 20 and/or the manifold 40. The valve housing 110 may be provided with the valve seat 130 having/forming an inflow passage 131 through which the hydrogen fuel passes.

### Valve Body

The valve body 120 may be inserted into and/or mounted (e.g., firmly, securely, fixedly, etc.) on the cylindrical portion 111 of the valve housing 110.

The valve body 120 may include the valve plunger 140, which may be movably provided inside the plunger mounting space 121 and/or may selectively open or close the fuel passage 124 (e.g., based on movement/position inside the plunger mounting space 121). An elastic body mounting space 122 may be formed by the valve body 120 and/or the valve plunger 140. An elastic body 150 (e.g., comprising an elastically supporting spring) may be inserted in the elastic body mounting space 122 (e.g., formed by the valve plunger 140). The elastic body mounting space 122 may be formed in/by a center of a rear surface (e.g., away from an inlet to the fuel passage 140) of the valve plunger 140.

Further, the valve body 120 may include a force distributing mechanism mounting space 123 formed at a position adjacent to the elastic body mounting space 122.

The elastic body mounting space 122 may be a space in which the elastic body 150 exerts an elastic force while compressed or stretched. Further, the force distributing mechanism mounting space 123 (which may be referred to as a force distributing base mounting space, a force distributing frame mounting space, etc.) may be a space on which a force distributing mechanism 160 (which may be referred to as a force distributing base, a force distributing frame, etc.) configured to move/cause movement of a fluid (e.g., due to a pressure of the elastic body 150) is mounted. The plunger mounting space 121, the elastic body mounting space 122, and the force distributing mechanism mounting space 123 may be in communication with each other (e.g., form a contiguous space).

### Valve Plunger

The valve plunger 140 may include a protrusion 141 protruding toward an inlet of the valve housing 110 (e.g., from a center of the valve plunger 140 and/or positioned to align with the inlet of the valve housing 110). The protrusion 141 may protrude into the inlet to maintain airtightness by pressing a tip against/into the inflow passage 131 of the valve seat 130. When/if the hydrogen fuel is introduced into the inlet of the valve housing 110 (e.g., when the hydrogen fuel is being filled), the valve plunger 140 may move to secure a flow path for the hydrogen fuel. When/if the hydrogen fuel is completely filled, surface pressure between the valve seat 130 and the valve plunger 140 may be generated to maintain airtightness.

The valve plunger 140 may include a first sealing member 142 (e.g., a seal) for sealing an outer circumferential surface of the valve plunger 140 to align movement of the valve plunger 140 and preventing pressure leakage.

The force distributing mechanism mounting space 123 may be equipped with the force distributing mechanism 160 that moves forward and backward (e.g., towards the valve plunger 140 or away from the valve plunger) by a pressure fluctuation caused by/of a fluid.

### Force Distributing Mechanism

In an environment in which the hydrogen fuel is filled (e.g., to the hydrogen fuel system) via the hydrogen filling line 12, the force distributing mechanism 160 may transmit an operating pressure as a flow pressure of the hydrogen fuel introduced into an inlet side of the valve housing 110 becomes greater than a pressure on the hydrogen tank 30. The valve plunger 140 and the elastic body 150 may move toward the outlet due to this pressure difference. Movement of the valve plunger 140 and the elastic body 150 may compress the elastic body, generating force applied to the force distributing mechanism 160, which may be transmitted as the operating pressure.

Further, in a high-pressure environment in which a high pressure state is applied to the fuel passage 124 due to reverse flow of the hydrogen fuel, the force distributing mechanism 160 transmits the operating pressure to the elastic body 150 due to the flow pressure of the hydrogen fuel introduced through/via an outlet side of the valve housing 110. In this situation, the valve plunger 140 may be compressed against the valve seat 130.

The force distributing mechanism 160 may include a first cylinder 161 (e.g., a cylindrical space towards an inlet side of the valve housing 110) and a second cylinder 163 (a cylindrical space towards the outlet side of the valve housing 110) and a connection pipe 165 between/connecting the first cylinder 161 and the second cylinder 163.

A first piston 162 and a second piston 164 may be configured to transmit the flow pressure into an internal fluid in the force distributing mechanism (dashed hashes in FIG. 4, for example). For example, flow pressure may be transmitted into the internal fluid due to adjustments of/changes in positions of the first piston 162 and the second piston 164 inserted into the first cylinder 161 and the second cylinder 163, respectively. The first cylinder 161 and the first piston 162 may be provided on the inlet side of the valve housing 110, and the second cylinder 163 and the second piston 164 may be provided on the outlet side of the valve housing 110.

The internal fluid may comprise oil, for example. The internal fluid may fill/be stored in the first cylinder 161, the second cylinder 163, and the connection pipe 165. The internal fluid may transmit the flow pressure to the first piston 162 and/or the second piston 164 (e.g., while/by moving along the connection pipe 165).

The first cylinder 161 into which the first piston 162 is inserted may be installed above the force distributing mechanism mounting space 123 (e.g., toward an inlet of the valve housing 110), the second cylinder 163 into which the second piston 164 is inserted may be installed below the force distributing mechanism mounting space 123 (e.g., toward an outlet of the valve housing 110), and the connection pipe 165 may be connected therebetween.

In the force distributing mechanism 160, when/if the first piston 162 or the second piston 164 moves (e.g., due to an applied pressure and/or thereby transmitting the applied pressure to the fluid stored in the first cylinder 161 or the second cylinder 163), the second piston 164 or the first piston 162 facing each other moves in a direction in which a fluid pressure is applied within the second cylinder 163 or the first cylinder 161.

Thus, when/if the atmospheric pressure outside the valve housing 110 and the elastic body mounting space 122 are maintained at the same pressure (e.g., by a drain passage part 170, e.g., a drain passage) and while the flow pressure of the hydrogen fuel is applied to the inlet side of the valve housing 110 (e.g., in the environment in which/if/when the hydrogen fuel is filled through/via the hydrogen filling line 12) and when the elastic force of the elastic body 150 is reversed, opening pressure performance may be maintained at a low level (e.g., at a relatively low level), the valve plunger 140 may be spaced apart from the valve seat 130, and thus the inlet of the valve housing 110 may be easily opened. Further, as the opening pressure performance of the valve plunger 140 decreases (e.g., as in the presently disclosed check valve 100), a pressure difference between both ends of the check valve 100 may decrease, and occurrence of abnormal operation noise due to a chattering phenomenon of the check valve 100 may be prevented.

Further, in the high-pressure environment in which the high pressure state is applied to the fuel passage 124 due to the reverse flow of the hydrogen fuel, a high-pressure hydrogen fuel may be applied to the outlet side of the valve housing 110, and thus in a state in which a pressure of the outlet side of the valve housing 110 is a first pressure, the pressure of the elastic body mounting space 122 may be a second pressure that is relatively lower than the first pressure. As a result of the pressure difference, the first piston 162 of the force distributing mechanism 160 may move in an inlet direction, a tensile length of the elastic body 150 may decrease, an additional pressure is transferred to the inflow passage 131 of the valve seat 130, and thus, the valve plunger 140 may be compressed with a stronger pressure. Accordingly, the airtight performance of the check valve 100 may be maintained, and not only leakage of the hydrogen fuel but also the reverse flow of the hydrogen fuel may be prevented.

The first piston 162 and the second piston 164 may include a second sealing member 166, such as an O-ring, for sealing outer circumferential surfaces thereof to control a flow rate of the fluid and prevent leakage of the fluid.

### Drain Passage Part

The elastic body mounting space 122 may be provided with/in communication with the drain passage part 170 (e.g., the drain passage). The drain passage part 170 may communicate with the outside of the valve housing 110 and/or may allow an internal pressure of the elastic body mounting space 122 to be discharged and/or be balanced (e.g., with the atmospheric pressure). The drain passage part 170 may include a first through passage 171 passing through/from the elastic body mounting space 122 of the valve body 120 and a second through passage 172 connected to the first through passage 171 and passing to the outside through the valve housing 110.

The drain passage part 170 may connect the outside of the valve housing 110 and the elastic body mounting space 122 inside the check valve 100 so that the internal pressure of the elastic body mounting space 122 may be balanced with the atmospheric pressure outside the valve housing 110.

When/if the atmospheric pressure outside the valve housing 110 and the elastic body mounting space 122 are maintained at the same pressure by the drain passage part 170, pressure resistance does not occur in the valve plunger 140, and thus the valve plunger 140, which blocks the inflow passage 131 of the valve seat 130, blocks the inlet of the valve housing 110 only with the elastic force of the elastic body 150 (e.g., not back pressure in the hydrogen filling system 10). Thus, when/if the hydrogen fuel is filled/being filled, and/or when/if the hydrogen fuel is introduced through the inlet of the valve housing 110, an opening pressure of the valve plunger 140 (e.g., a pressure to open the inlet by moving back the valve plunger) may be lowered, and thus the hydrogen fuel may be easily introduced.

In this case, a differential pressure may be generated between the fuel passage 124 and the elastic body mounting space 122 of the valve body 120.

Hereinafter, in describing the check valve 100 according to second and third examples of the present disclosure, the same reference numerals are used for components having the same configuration and the same function as those according to the first example of the present disclosure, and detailed descriptions of these components will be omitted to avoid repetitive configurations.

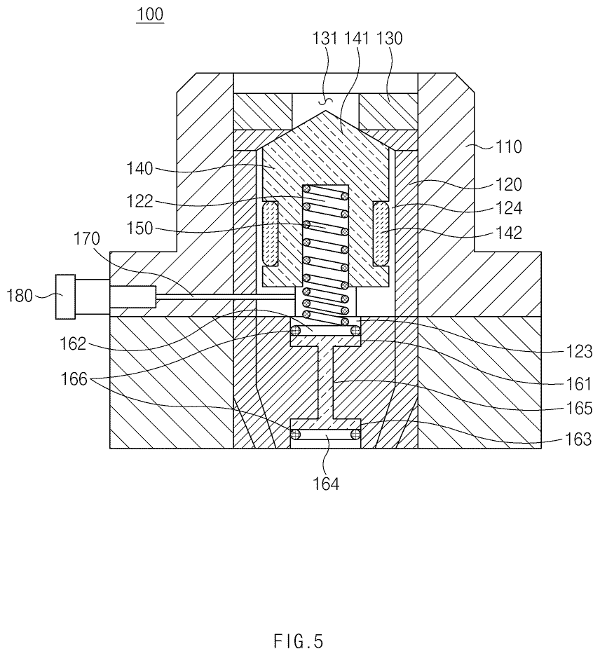

FIG. 5 is a cross-sectional view illustrating the check valve 100 according to the second example of the present disclosure.

### Drain Valve

As illustrated in FIG. 5, it may be necessary/beneficial to decrease the pressure of the elastic body mounting space 122 so that the internal pressure of the elastic body mounting space 122 may be balanced with the atmospheric pressure outside the valve housing 110. To this end, a drain valve 180, which is connected to the drain passage part 170, may be configured to forcibly discharge an internal fluid of the elastic body mounting space 122.

The drain valve 180 may be installed in the drain passage part 170 connected to the elastic body mounting space 122 in which the elastic body 150 is supported and/or guided.

As an example, the drain valve 180 may be/comprise an electronic purge valve. The drain valve 180 may measure the pressure of the elastic body mounting space 122 and/or discharge the internal fluid of the elastic body mounting space 122 to maintain a reference pressure and/or pressure within a reference pressure range (e.g., when/if the pressure of the elastic body mounting space 122 deviates from a reference pressure, such as when/if the pressure of the elastic body mounting space 122 is greater than the atmospheric pressure, etc.).

The pressure of the elastic body mounting space 122 by which the elastic body 150 is supported may be removed/reduced/managed using the drain valve 180. The internal pressure of the elastic body mounting space 122 may be balanced with the atmospheric pressure outside the valve housing 110. As such, the opening pressure of the valve plunger 140 may be improved/reduced. Thus, when/if the hydrogen fuel is introduced through the inlet of the valve housing 110, the opening pressure of the valve plunger 140 may be lowered so that the hydrogen fuel may be easily introduced.

Using a drain valve 180 to forcibly discharge internal fluid of the elastic mounting space 122 may more quickly/effectively balance the pressure of the elastic body mounting space 122 with the atmospheric pressure relative to allowing passive balancing by the drain passage part 170 alone.

An inflow amount of the hydrogen fuel introduced into the inlet side of the valve housing 110 may be transferred and/or input to an electronic control unit (ECU; not illustrated). For example, the inflow amount of the hydrogen fuel (e.g., a total amount to be introduced and/or a flow rate/pressure at which the hydrogen fuel is to be introduced) may be input to the ECU (e.g., via a user input to an interface of the ECU and/or via a sensor detecting the inflow amount (e.g., detected inflow pressure, etc.). The ECU may, based on the inflow amount, control an opening amount of the drain valve 180 to discharge the internal fluid of the elastic body mounting space 122 so as to discharge the internal pressure to the outside of the valve housing 110. Accordingly, the pressure of the elastic body mounting space 122 may be the same as the atmospheric pressure, and the opening pressure of the valve plunger 140 may be improved/reduced.

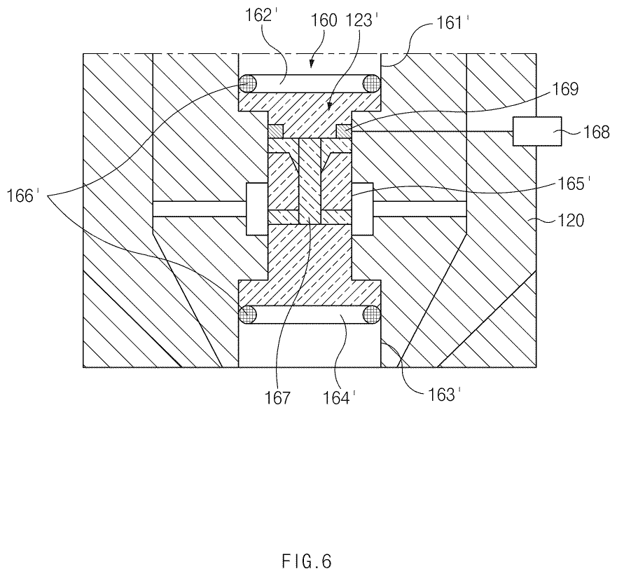

FIG. 6 is a cross-sectional view illustrating the check valve 100 according to a third example of the present disclosure.

Referring to FIG. 6, the force distributing mechanism 160 configured to move forward or rearward due to a pressure fluctuation is excluded. Instead, a force distributing mechanism 160′ including an actuator 167 that transmits the operating pressure to the fluid via power application may be included.

The force distributing mechanism 160′ includes a first cylinder 161′ and a second cylinder 163′ on the inlet side and the outlet side, respectively, of the valve housing 110 and a connection pipe 165′ between the first cylinder 161′ and the second cylinder 163′.

A first piston 162′ and a second piston 164′ (e.g., that transmit the flow pressure to the internal fluid due to adjustment/change in positions of the first piston 162′ and the second piston 164′) are inserted into the first cylinder 161′ and the second cylinder 163′, respectively. The first cylinder 161′ and the first piston 162′ may be provided on the inlet side of the valve housing 110, and the second cylinder 163′ and the second piston 164′ may be provided on the outlet side of the valve housing 110.

The internal fluid (e.g., such as oil) may be stored in the first cylinder 161′, the second cylinder 163′, and the connection pipe 165′. The internal fluid may transmit the flow pressure to the first piston 162′ or the second piston 164′ via the connection pipe 165′.

The first cylinder 161′ (e.g., into which the first piston 162′ is inserted) may be installed/positioned above a force distributing mechanism mounting space 123′, the second cylinder 163′ (e.g., into which the second piston 164′ is inserted) may be installed below the force distributing mechanism mounting space 123′. The connection pipe 165′ may connect the first cylinder 161′ and the second cylinder 163′. The actuator 167 may be configured to transmit the operating pressure to the fluid in/by a power application manner. The actuator 167 may be provided in the connection pipe 165′. The actuator 167 may include a power connector 168 connected to a power source and a power transmission part 169 (e.g., a wire) connected to the power connector 168. The example of the present disclosure is not limited to a wired power supply manner, and a wireless power supply manner may also or alternatively be applied and used.

Further, the example of the present disclosure may be applied in various ways, including a component capable of transmitting the operating pressure to the fluid using a piezo manner as well as/instead of the actuator 167.

In the force distributing mechanism 160′, when/if electric power is applied to the actuator 167, the actuator 167 may move in a direction of the outlet side of the valve housing 110. When/if the fluid pressure is transmitted to the second piston 164′, the second piston 164′ may move in a direction toward the outlet in which the fluid pressure is applied within the second cylinder 163′.

When/if electric power to the actuator 167 is cut off, the actuator 167 may move in a direction toward the inlet of the valve housing 110. When/if the fluid pressure is transmitted to the first piston 162′, the first piston 162′ may move in a direction toward the inlet in which the fluid pressure is applied within the first cylinder 161′.

When/if the hydrogen fuel is filled/being filled, and when/if the elastic force of the elastic body 150 elastically supported by (e.g., attached to) the valve plunger 140 deviates from a reference elastic force (e.g., when/if the elastic force of the elastic body 150 is greater than the pressure of the hydrogen fuel) the opening pressure of the valve plunger 140 may increase. When/if the inlet of the valve housing 110 is not open, the actuator 167 may transmit the operating pressure to the second piston 164′ of the force distributing mechanism 160′ to forcibly open the valve plunger 140 (e.g., when/if the elastic force is greater than the pressure of the hydrogen fuel such that the inlet does not open by hydrogen filling alone).

When/if an inflow amount of the hydrogen fuel introduced into the inlet side of the valve housing 110 is transferred and input to the ECU (e.g., if a desired/required amount of hydrogen flow is input to the ECU and/or an amount of hydrogen fuel, such as a pressure and/or flow amount of hydrogen fuel flow into the hydrogen filling system, is sensed by a sensor and input to the ECU), the ECU may determine whether the inlet of the valve housing 110 is open. If it is determined that the inlet side is not open, the ECU may control the actuator 167 to move the second piston 164′ of the force distributing mechanism 160′ toward the outlet of the valve housing 110. Accordingly, the valve plunger 140 and/or the elastic body 150 may move toward the outlet of the valve housing 110, the valve plunger 140 may be open (e.g., may move out from the inlet of the valve housing 110, to open the inlet), and/or the opening pressure of the valve plunger 140 may be improved.

A hole cap 190 may be configured to prevent the drain passage part 170 from communicating with the outside of the valve housing 110 (e.g., after the drain passage part 170 is processed). This hole cap may be generally fixed via/by screw fastening.

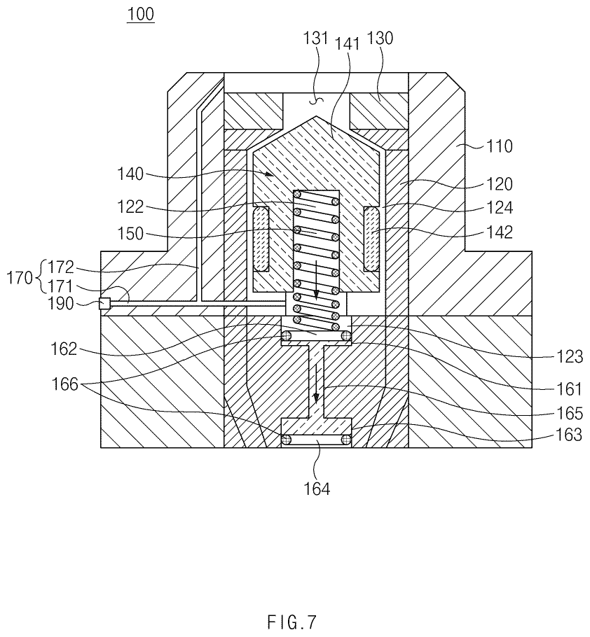

FIG. 7 is a view illustrating an operation state of the check valve 100 in an environment in which a hydrogen fuel is filled/being filled according to the first example of the present disclosure.

As illustrated in FIG. 7, when/if the hydrogen fuel is filled in the hydrogen tank 30, and when/if the hydrogen fuel flowing along the hydrogen filling line 12 (provided between the receptacle 20 and the manifold 40) is introduced into the inlet of the valve housing 110 of the check valve 100, in a situation in which the pressure of the elastic body mounting space 122 is balanced with the atmospheric pressure outside the valve housing 110, the valve plunger 140 may move toward the outlet of the valve housing 110 by the fluid pressure of the hydrogen fuel introduced into the inlet of the valve housing 110. In this case, when/if the hydrogen fuel is filled, and when/if a force by which the hydrogen fuel is introduced through the inlet is greater than the elastic force of the elastic body 150 and a force applied to the outlet side due to the reverse flow of the hydrogen fuel of the hydrogen tank 30 (e.g., if the force by which the hydrogen fuel is introduced is greater than a sum of the elastic force and the force applied to the outlet side), the valve plunger 140 may move toward the outlet of the valve housing 110. A difference between a pressure P1 by which the hydrogen fuel is introduced through the inlet and a pressure P2 applied toward the outlet may be referred to as the opening pressure of the check valve 100.

When/if the valve plunger 140 moves toward the outlet of the valve housing 110, the first piston 162 of the force distributing mechanism 160 (e.g., by which the elastic body 150 is supported) may move towards the outlet, thereby transmitting the operating pressure to the internal fluid of the first cylinder 161.

When/if the internal fluid of the first cylinder 161 transmits the operating pressure to the second piston 164 (e.g., via the connection pipe 165), the second piston 164 may move toward the outlet of the valve housing 110. Thus, the valve plunger 140, the elastic body 150, the first piston 162, and the second piston 164 may move toward the outlet of the valve housing 110.

In a situation in which the flow pressure of the hydrogen fuel is continuously applied, the opening pressure of the valve plunger 140 may decrease/be reduced.

Thus, the pressure difference between both ends of the check valve 100 may decrease/be reduced. The lower pressure difference may reduce/prevent the occurrence of the abnormal operation noise due to the chattering phenomenon of the check valve 100.

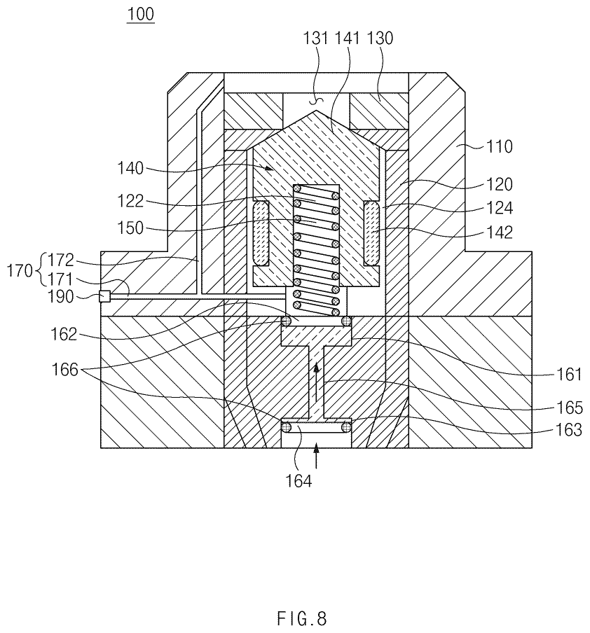

FIG. 8 is a view illustrating an operation state of the check valve 100 in an environment in which the hydrogen fuel is provided at a high pressure (e.g., according to the first example of the present disclosure).

As illustrated in FIG. 8, in a high-pressure environment in which the hydrogen fuel having a high pressure (e.g., about 700 bar or greater) flows back through the outlet side of the valve housing 110 and a high-pressure state is applied to the fuel passage 124, the second piston 164 (e.g., located on the outlet side of the force distributing mechanism 160) may move towards the inlet side of the valve housing 110 (e.g., by the flow pressure of the hydrogen fuel introduced into the outlet side of the valve housing 110), thereby transmitting the operating pressure to the internal fluid of the second cylinder 163.

When/if the internal fluid of the second cylinder 163 transmits the operating pressure to the first piston 162 (e.g., by flowing through the connection pipe 165 and/or by transmission of the pressure via fluid in the connection pipe 165 and/or in the first cylinder 161), the first piston 162 may move toward the inlet of the valve housing 110.

When/if the first piston 162 moves by the operating pressure of the force distributing mechanism 160, the operating pressure may be transmitted to the elastic body 150 elastically supported by (e.g., connected to) the first piston 162, the elastic body 150 may move with the movement of the first piston 162, and thus the valve plunger 140 may be compressed against the valve seat 130.

Since the elastic body mounting space 122 may be maintained at the same pressure as the atmospheric pressure outside the valve housing 110, an additional pressure may be transmitted due to a pressure difference between the fuel passage 124 and the elastic body mounting space 122. Thus the valve plunger 140 may be compressed against the valve plunger 140 with a stronger pressure (e.g., than if the elastic body mounting space 122 is not maintained at atmospheric pressure). Accordingly, the airtight performance of the check valve 100 may be maintained, and not only the leakage of the hydrogen fuel but also the reverse flow of the hydrogen fuel may be prevented.

The present disclosure has been made to solve the above-mentioned problems occurring in the prior art while advantages achieved by the prior art are maintained intact.

An aspect of the present disclosure provides a check valve that may reduce a pressure difference between both ends of the check valve by lowering an opening pressure of a valve plunger in an environment in which a hydrogen fuel is filled and prevent occurrence of abnormal operation noise due to a chattering phenomenon.

Another aspect of the present disclosure provides a check valve that may prevent reverse flow of a hydrogen fuel as well as leakage of the hydrogen fuel as a valve plunger secures a stronger surface pressure on a valve seat and maintains airtightness performance in a high-pressure environment in which a high-pressure state is applied to a fuel passage due to the reverse flow of the hydrogen fuel.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a check valve includes a valve housing in which a valve seat is installed, a valve body installed inside the valve housing and including a fuel passage between an inlet and an outlet thereof, a valve plunger that is movably provided inside the valve body, selectively opens or closes the valve seat, and has an elastic body mounting space, an elastic body inserted into the elastic body mounting space and elastically supporting the movement of the valve plunger, a force distributing mechanism that transmits, to a fluid, a flow pressure of a hydrogen fuel introduced through an inlet side or an outlet side of the valve housing so as to adjust a position of the valve plunger, and a drain passage part that discharges a pressure of the elastic body mounting space while allowing an outside of the valve housing and the elastic body mounting space to communicate with each other.

According to an example of the present disclosure, the valve body may further include a plunger mounting space in which the valve plunger is movably provided and a force distributing mechanism mounting space on which the force distributing mechanism through which a fluid moves due to a pressure of the elastic body is mounted.

According to an example of the present disclosure, the valve plunger may include a first sealing member that seals an outer circumferential surface thereof.

According to an example of the present disclosure, the force distributing mechanism may include a first cylinder and a second cylinder provided on the inlet side and the outlet side of the valve housing, a connection pipe provided between the first cylinder and the second cylinder, and a first piston and a second piston of which positions are adjusted by the first cylinder and the second cylinder and which transmit the flow pressure to an internal fluid stored in the first cylinder, the second cylinder and the connection pipe.

According to an example of the present disclosure, the force distributing mechanism may include a first cylinder and a second cylinder provided on the inlet side and the outlet side of the valve housing, a connection pipe provided between the first cylinder and the second cylinder, a first piston and a second piston of which positions are adjusted by the first cylinder and the second cylinder, and an actuator that is positioned between the first piston and the second piston and transmits the flow pressure to an internal fluid stored in the first cylinder, the second cylinder, and the connection pipe through a power application manner.

According to an example of the present disclosure, the first piston and the second piston may include a second sealing member that seals outer circumferential surfaces thereof.

According to an example of the present disclosure, the drain passage part may include a first through passage passing through the elastic body mounting space of the valve body and a second through passage connected to the first through passage and passing to the outside through the valve housing.

According to an example of the present disclosure, a drain valve that discharges an internal fluid of the elastic body mounting space may be connected to the drain passage part.

According to a check valve according to the present disclosure, a pressure difference between both ends of the check valve may be reduced by lowering an opening pressure of a valve plunger in an environment in which a hydrogen fuel is filled, and occurrence of abnormal operation noise due to a chattering phenomenon may be prevented.

Reverse flow of a hydrogen fuel as well as leakage of the hydrogen fuel may be prevented as a valve plunger is compressed against a valve with a stronger pressure and maintains airtightness performance in a high-pressure environment in which a high-pressure state is applied to a fuel passage due to the reverse flow of the hydrogen fuel.

The above description of the present disclosure is for illustration, and those skilled in the art to which the present disclosure pertains may understand that the present disclosure may be easily modified into other specific forms without changing the technical spirit or essential feature of the present disclosure. Therefore, it should be understood that the examples described above are illustrative but not limiting in all aspects. The scope of the present disclosure is indicated by the appended claims, and all changes or modifications derived from the meaning and scope of the appended claims and equivalent concepts thereof should be construed as being included in the scope of the present disclosure.

What is claimed is:

1. A check valve comprising:
a valve housing comprising a valve seat at an inlet of the valve housing;
a valve body forming a fuel passage between an inlet of the valve body and an outlet of the valve body;
a valve plunger, movable inside the valve body, configured to selectively open or close the valve seat, and forming an elastic body mounting space;
an elastic body, in the elastic body mounting space, elastically connected to the valve plunger;
a force distributing base comprising a first piston and a second piston with a fluid therebetween, wherein the first piston and the second piston are configured to transmit, via the fluid and to each other, a flow pressure of a hydrogen fuel; and
a drain passage configured to allow the elastic body mounting space to communicate pressure with an outside of the valve housing.

2. The check valve of claim 1, wherein the valve body further forms:
a plunger mounting space in which the valve plunger is movably provided; and
a force distributing base mounting space in which the force distributing base is provided, wherein the elastic body mounting space is between the plunger mounting space and the force distributing base mounting space.

3. The check valve of claim 1, wherein the valve plunger comprises a first seal configured to seal an outer circumferential surface of the valve plunger.

4. The check valve of claim 2, wherein the force distributing base comprises:
a first cylinder provided toward the inlet of the valve housing;
a second cylinder provided toward the outlet of the valve housing; and
a connection pipe provided between the first cylinder and the second cylinder,
wherein the first piston is provided in the first cylinder, the second piston is provided in the second cylinder, and wherein the fluid is stored in a space formed between the first piston and the second piston and in the first cylinder, the second cylinder, and the connection pipe.

5. The check valve of claim 4, wherein the force distributing base further comprises:
an actuator positioned between the first piston and the second piston and configured to transmit, by moving at least one of the first piston or the second piston, a hydrogen flow pressure to the fluid stored in the first cylinder, the second cylinder, and the connection pipe through a power application.

6. The check valve of claim 1, further comprising:
a second seal configured to seal an outer circumferential surface of the first piston; and
a third seal configured to seal an outer circumferential surface of the second piston.

7. The check valve of claim 1, wherein the drain passage comprises:
a first passage extending from the elastic body mounting space of the valve body; and
a second passage connecting the first passage to the outside of the valve housing.

8. The check valve of claim 1, further comprising a drain valve, connected to the drain passage, configured to discharge an internal fluid of the elastic body mounting space to outside of the valve housing.

9. A check valve comprising:
a valve housing;
valve seat;
a valve body forming a fuel passage between a first end of the valve body and a second end of the valve body;
a valve plunger, movable inside the valve body, configured to selectively open or close the valve seat, and forming an elastic body mounting space;
an elastic body, in the elastic body mounting space, elastically connected to the valve plunger;
a first piston disposed in a first cylinder, wherein the elastic body is elastically connected to the first piston;
a second piston disposed in a second cylinder; and
a fluid, filling a space formed between the first piston and the second piston, and configured to transmit a force applied to either the first piston or the second piston to the other of the first piston or the second piston.

10. The check valve of claim 9, further comprising a drain passage configured to allow the elastic body mounting space to communicate pressure with an outside of the valve housing.

11. The check valve of claim 10, wherein the drain passage comprises:
a first passage extending from the elastic body mounting space of the valve body; and
a second passage connecting the first passage to the outside of the valve housing.

12. The check valve of claim 10, further comprising a drain valve, connected to the drain passage, configured to discharge an internal fluid of the elastic body mounting space to the outside of the valve housing.

13. The check valve of claim 9, wherein the valve plunger comprises a first seal configured to seal an outer circumferential surface of the valve plunger.

14. The check valve of claim 9, wherein the fluid comprises an oil.

15. The check valve of claim 9, further comprising:
a connection pipe formed between the first cylinder and the second cylinder; and
an actuator positioned between the first piston and the second piston and configured to transmit, by moving at least one of the first piston or the second piston, a hydrogen flow pressure to the fluid stored in the first cylinder, the second cylinder, and the connection pipe.

16. The check valve of claim 15, further comprising a computing device configured to control the actuator based on input indicating hydrogen fuel flow towards an inlet of the check valve.

17. The check valve of claim 9, further comprising:
a connection pipe formed between the first cylinder and the second cylinder,
wherein a first area of the connection pipe that faces the first cylinder is smaller than an area of a circular base of the first cylinder, and
wherein a second area of the connection pipe that faces the second cylinder is smaller than an area of a circular base of the second cylinder.

18. The check valve of claim 17, further comprising:
an actuator disposed in the connection pipe and configured to transmit a hydrogen flow pressure to the fluid stored in the first cylinder, the second cylinder, and the connection pipe.

19. The check valve of claim 9, further comprising:
a second seal configured to seal an outer circumferential surface of the first piston comprises a second seal configured to seal an outer and
a third seal configured to seal an outer circumferential surface of the second piston.

20. A check valve comprising:
a valve housing;
a valve seat;
a valve body forming a fuel passage between a first end of the valve body and a second end of the valve body;
a valve plunger, movable inside the valve body, configured to selectively open or close the valve seat, and forming an elastic body mounting space;
an elastic body, in the elastic body mounting space, elastically connected to the valve plunger;
a drain passage configured to selectively allow pressure balancing between the elastic body mounting space and an outside of the valve housing; and
an electronic control circuit configured to control, based on an inflow amount of hydrogen fuel flowing into the valve body, an opening of the drain passage to allow the pressure balancing between the elastic body mounting space and the outside of the valve housing.
